(19) United States
(12) Patent Application Publication
(10) Pub. No.: US 2024/0030790 A1
(43) Pub. Date: Jan. 25, 2024

(54) METHOD AND APPARATUS FOR PRODUCING A STATOR OF A DYNAMO-ELECTRIC MACHINE

(71) Applicant: ATOP S.P.A., Barberino Tavarnelle (IT)

(72) Inventors: Massimo PONZIO, Colle Val D'Elsa (IT); Giovanni MANUELLI, Ponte a Ema (IT); Alessandro MARCHI, San Casciano in Val di Pesa (IT)

(73) Assignee: ATOP S.P.A., Barberino Tavarnelle (IT)

(21) Appl. No.: 18/265,939

(22) PCT Filed: Dec. 2, 2021
(86) PCT No.: PCT/IB2021/061253

§ 371 Date: Jun. 7, 2023

(30) Foreign Application Priority Data
Dec. 9, 2020 (EP) 20212904.5

(51) Int. Cl. H02K 15/02

(52) U.S. Cl. CPC H02K 15/026

(57) ABSTRACT

Embodiments of the present disclosure may include producing a stator of a dynamo-electric machine. The method may include moving along a predetermined rectilinear trajectory a train of pole members arranged according to a predetermined starting spatial orientation. At a predetermined passage position, a first pole member and one or more intermediate pole members may pass from the rectilinear trajectory to a circular trajectory having a centre. In some embodiments, the method may include positioning a last pole member of the train along the circular trajectory adjacent to the first pole member and to the last intermediate pole member changing, at a change position its spatial orientation from the predetermined starting spatial orientation to a final spatial orientation in which it is radially oriented with respect to the centre of the circular trajectory.

### FIELD OF THE INVENTION

The present invention relates to a method for producing a stator of a dynamo-electric machine.

In particular the invention relates to a method for producing an annular stator by assembling together a plurality of pole members wound by an electric wire W for forming respective coils B.

Furthermore, the invention relates to an apparatus for producing an annular stator of a dynamoelectric machine by assembling together a plurality of pole members wound by an electric wire W for forming respective coils B.

### DESCRIPTION OF THE PRIOR ART

As it is known, after winding, the pole members are assembled together one next to the other to form a wound core, which is normally a stator component of an electric motor having the field of the pole members directed internally. During winding of the pole members, a predetermined number of turns of electric wire needs to be delivered and positioned with accuracy to form the coils. The turns of the coils need to be stratified with a required position precision, and the conductor stretches which form the turns need to be regularly positioned.

Furthermore, continuous wire stretches, often referred to as connections leads or connection bridges, can connect one or more pairs of the coils of the pole members to form a required electric scheme of the stator component.

Winding and assembly of pole members according to these principles are for example described in EP 1098425 and EP 1629588, EP3008798. In EP 1098425 pliers are provided for holding the pole members. Each plier is moveable on a respective movement device of a transfer table to position the pole members for winding and assembly of a stator. The pole members are secured to the pliers by catches that are assembled on the pliers. Each plier is provided with a shelf for abutment of the lower end of a pole member. EP 3008798 illustrates a holder where single poles are positioned for winding and connection leads are disposed for connecting the coils.

A method for producing an annular stator by assembling together wound poles is also described in U.S. Pat. No. 9,882,457. More in detail, the method for producing annular stators described in U.S. Pat. No. 9,882,457 provides to insert a plurality of wound poles into a curvilinear slot of a device for moving a row of poles members into an annular assembly of a stator. The curvilinear slot has a cross-sectional shape that corresponds to the cross-sectional shape of a wound pole member and comprises a rectilinear insertion section, a spiral transition section and an annular section. The row of poles positioned in the rectilinear insertion section is pushed through the section of the curvilinear path into the annular section where an end position is reached in which the row of poles forms the annular configuration. The poles are then removed from the annular section using a gripping device and held together in a pressed state.

However, the method for assembling an annular stator described in U.S. Pat. No. 9,882,457 presents notable complications in guaranteeing the positioning of the poles members by pushing through a slot, which needs to assure accuracy by the engagement of the pole members with the sides of the slot.

When connection leads are required between the poles, like is shown with the holder of EP3008798, or with connection leads having different connection paths, the assembly of the pole members to form the angular configuration of the stator requires transferring the assembled pole members together with the connection leads to achieve the assembly of the pole members. This transfer becomes a complicated operation in achieving accurate final positioning of the pole members and the connections leads.

Other examples of method and apparatus of prior art for assembling annular stators having similar inconveniences are described in US2005/082919 and EP0652622.

### SUMMARY OF THE INVENTION

It is, therefore, an object of the present invention to provide a method for producing a stator of a dynamo-electric machine by assembling together a plurality of wound poles that is able to overcome the aforementioned drawbacks of the machines of prior art.

It is also an object of the present invention to provide a method for producing a stator of a dynamo-electric machine that allows to simplify and speed-up the assembly operations and at the same time to guarantee a very accurate positioning of the poles forming the stator and of the connection leads that may be present between the poles.

It is also an object of the present invention to provide a method for producing a stator of a dynamo-electric machine that achieves assembly operations of the pole members in respective positions of an annular configuration of a stator, and at the same time guarantees that the connection leads of the pole members are positioned on predetermined trajectories proximal to an end of the assembled stator.

In particular it is an object of the present invention to provide a method for producing a stator of a dynamo-electric machine that allows to avoid excessive bending of the portions of the connection leads present between the poles, thus assuring the correct assembly and functioning of the dynamoelectric machine comprising such a stator.

It is also an object of the present invention to provide a method for producing a stator of a dynamo-electric machine that allows to avoid the need of excessive lengths of the portions of the connection leads present between the poles, thus achieving compactness of the stator and avoiding difficulties in positioning the connection leads.

It is a further object of the present invention to provide an apparatus for producing a stator of a dynamo-electric machine by assembling together a plurality of wound poles having analogous advantages.

These and other objects are achieved by the method, according to the invention, for producing a stator of a dynamo-electric machine by assembling together a plurality of pole members wound by a wire (W) around a respective winding axis forming respective coils (B), said method comprising the steps of:
moving along a predetermined rectilinear trajectory a train of pole members comprising said plurality of poles positioned side by side, said train of pole members comprising a first pole member, a last pole member, and a predetermined number of intermediate pole members positioned between said first and said last pole members, during said step of moving along the predetermined rectilinear trajectory, each pole member being arranged with the respective winding axis positioned according to a predetermined starting spatial orientation;
moving at a predetermined passage position P* of the rectilinear trajectory, the first pole member and the plurality of intermediate pole members each at a time from the rectilinear trajectory to a circular trajectory having a centre (C);
moving the first pole member and the intermediate pole members along said circular trajectory, during said step of moving along the circular trajectory, the first pole member and the intermediate pole members being caused to rotate around a rotation axis passing through said centre (C) in such a way that the winding axes of the first pole member and the intermediate pole members are directed towards the centre (C) of said circular trajectory;
causing at a change point (Pc) of said rectilinear trajectory positioned upstream of said passage position, the last pole member of said train of pole members to move forward from the rectilinear trajectory and to rotate around an instantaneous axis of rotation orthogonal to the respective winding axis to position the last pole member with the respective winding axis radially oriented with respect to said circular trajectory upstream of said passage position P* in such a way as to close the train of pole members by positioning the last pole member adjacent to the first pole member and to the intermediate pole member of the train of pole members which precedes the last pole member.

According to another aspect of the invention, an apparatus for producing a stator of a dynamo-electric machine by assembling together a plurality of pole members wound by a wire (W) around a respective winding axis forming respective coils (B), said apparatus comprising:
a first displacement device configured to move along a predetermined rectilinear trajectory a train of pole members comprising said plurality of pole members positioned side by side, said train of pole members comprising a first pole member, a last pole member, and a predetermined number of intermediate pole members positioned between the first and the last pole members, the first displacement device configured to move the plurality of pole members so as to maintain respective winding axes positioned according to a predetermined starting spatial orientation;
a second displacement device configured to cause, at a predetermined passage position P*, the first pole member and the plurality of intermediate pole members at a time to move from said predetermined rectilinear trajectory to a predetermined circular trajectory having a centre (C), and wherein said second displacement device is configured to move said plurality of pole members along the circular trajectory causing the plurality of pole members to rotate around a rotation axis passing through said centre (C) in such a way to maintain the winding axes of said pole members radially oriented with respect to the centre (C);
a device for changing at a change point (Pc) of the rectilinear trajectory positioned upstream of the passage position P*, the spatial orientation of the last pole member causing the last pole member to move forward from said rectilinear trajectory and to rotate around an instantaneous axis of rotation orthogonal to the respective winding axis to position the winding axis of the last pole member radially oriented with respect to the centre (C) of the circular trajectory in such a way to close the train of pole members by positioning the last pole member adjacent to the first pole member and to the intermediate pole member of the train of pole members which precedes the last pole member.

Other features of the present invention and related embodiments are set out in the dependent claims.

### BRIEF DESCRIPTION OF THE DRAWINGS

The invention will now be shown with the following description of its exemplary embodiments, exemplifying but not limitative, with reference to the attached drawings in which:

FIGS. 1 and 2 diagrammatically show, respectively, a front perspective view and a rear perspective view of an embodiment, according to the invention, of an apparatus for producing a stator by assembling together a plurality of pole members;

FIGS. 3 and 4A diagrammatically show, respectively, a front perspective view and a rear perspective view of a train of pole members that can be processed by the apparatus of FIGS. 1 and 2;

FIG. 4B diagrammatically shows an enlargement of a portion of FIG. 4A to highlight some characteristics of an embodiment of the train of pole members processed by the apparatus according to the invention;

FIG. 5 diagrammatically shows a sequence of difference positions occupied by an intermediate support member of the train of pole members of FIGS. 3 and 4 during the functioning of the apparatus of FIGS. 1 and 2;

FIG. 6 diagrammatically shows a sequence of different positions occupied by the last support member of the train of pole members of FIGS. 3 and 4 during the functioning of the apparatus of FIGS. 1 and 2;

FIG. 7 diagrammatically shows a sequence of two different positions occupied by the first support member of the train of pole members during the functioning of the apparatus of FIGS. 1 and 2;

FIGS. 8 to 11A diagrammatically show a sequence of different positions occupied by the train of pole members during the functioning of the apparatus of FIGS. 1 and 2;

FIG. 11B diagrammatically shows an enlargement of a portion of FIG. 11A in order to highlight some characteristics of the train of pole members processed by the apparatus according to the invention;

FIGS. 12, 13 and 14 diagrammatically show, respectively, a perspective view, a cross sectioned view and a plant view, of a possible embodiment of an intermediate support member according to the invention.

### DETAILED DESCRIPTION OF SOME EXEMPLARY EMBODIMENTS OF THE INVENTION

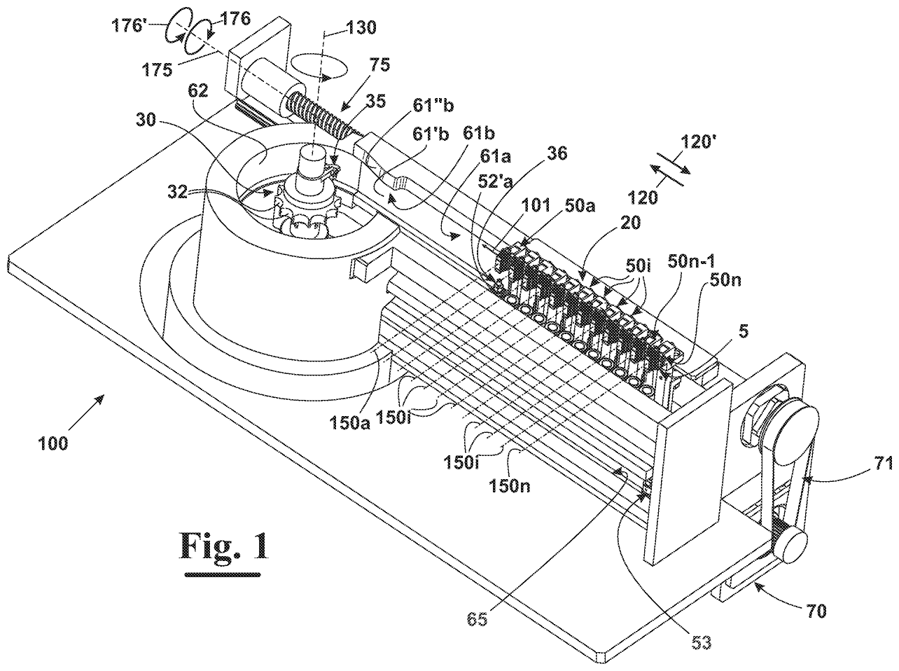

In the following pole members can be referred to as poles, for reasons of clarity. With reference to FIG. 1 an apparatus 100, according to the invention, for producing a stator, in particular an annular stator, of a dynamo-electric machine by assembling together a plurality of pole members 10 wound by a wire W around respective winding axis 150 forming respective coils B, comprises a first displacement device 20 configured to move a train of pole members 5 along a rectilinear trajectory 101. In particular, the train of pole members 5 comprises the plurality of pole members 10 positioned side by side along a predetermined rectilinear trajectory 101 and supported by a plurality of support members 50a-50n. In particular, the train of pole members 5 comprises a first pole member 10a supported by a respective first support member 50a, a predetermined number of intermediate pole members 10i each supported by a respective intermediate support member 50i, and a last pole member 10n supported by a respective last support member 50n.

More particularly, the pole members 10a, 10i and 10n supported on the respective support members 50a, 50i and are positioned according to a predetermined starting spatial orientation during their movement carried out by a first displacement device 20 along the rectilinear trajectory 101. More precisely, as diagrammatically shown in FIGS. 1, 2 and 5, each pole member 10a, 10i and 10n has a respective winding axis 150a, 150i and 150n, which is directed towards a first direction during the movement of the pole members 10a, 10i and 10n by the first displacement device 20 along the rectilinear trajectory 101.

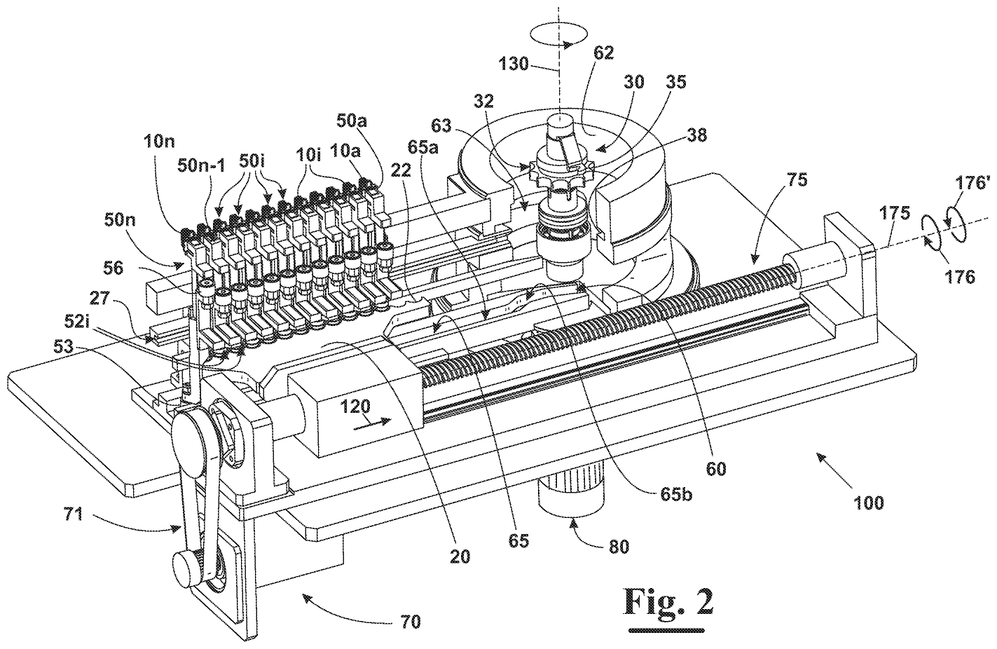

The first displacement device 20 can be operated by an endless screw 75 (see FIGS. 1 and 2), which can be caused to rotate about its rotation axis 175 in a first rotation direction 176, or in a second opposite rotation direction 176′, by a motor, for example an electric motor 90, in particular through a transmission belt 71, in order to move the first displacement device 20 and, therefore, the train of pole members 5 in a first moving direction 120, or to move the first displacement device 20 back to a load position for loading a new train of pole members (not shown in the figures).

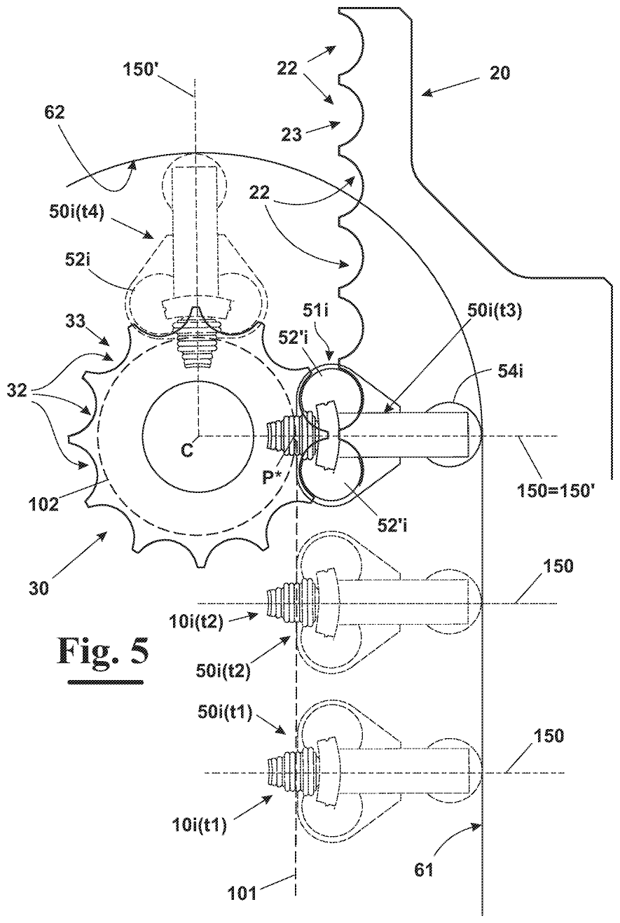

The apparatus 100, furthermore, comprises a second displacement device 30 (see for example FIGS. 1, 2 and 5), which is configured to cause, at a predetermined passage position P* (see for example FIG. 5) the first pole member and the intermediate pole members 10i supported by respective support members 50a and 50i, at a time, to move from the aforementioned predetermined rectilinear trajectory 101 to a predetermined circular trajectory 102 having a centre (C). In particular, when all the pole members 10a-10n of the train of pole members 5 are positioned along the circular trajectory 102 a required annular shape is achieved. More in detail, the second displacement device 30 is configured to move the train of pole members 5 along the circular trajectory 102 maintaining the poles 10 radially oriented with respect to the centre (C), i.e. with the respective winding axes 150a and 150i of the pole members, that is maintained directed towards centre (C) (see for example FIG. 5). According to an aspect of the invention, not shown in the figures for reasons of clarity, after all the poles 10a-10n of the train of pole members 5 have been positioned along the circular trajectory 102, they are radially pressed in order to achieve a final shape of the annular stator to be assembled.

In particular, with reference, for example, to figure at the predetermined passage position P*, the predetermined starting spatial orientation of each pole member 10a, 10i and 10n coincides with a radial direction with respect to the centre (C) of the circular trajectory 102 (see respective winding axis 150a, 150i and 150n directed towards centre (C) at the passage position P*). In FIG. 5, for reasons of explanation, only a support element is shown in different instants, in particular 4 different instants (t1,t2,t3,t4). More in detail, as shown in FIG. 5, during the movement of the pole members 10i along the rectilinear trajectory 101, its winding axis 150i (instants t1 and t2) is positioned according to the starting spatial orientation in particular orthogonal to the rectilinear trajectory 101. However, when the support member arrives at passage position P* (instant t3) the spatial orientation of winding axis 150i coincides with the radial direction 150′ directed towards centre (C) of the circular trajectory 102, and continues to remain radially oriented (instant t4) with winding axis 150i directed towards centre (C) during the movement of the pole members 50i along the circular trajectory 102.

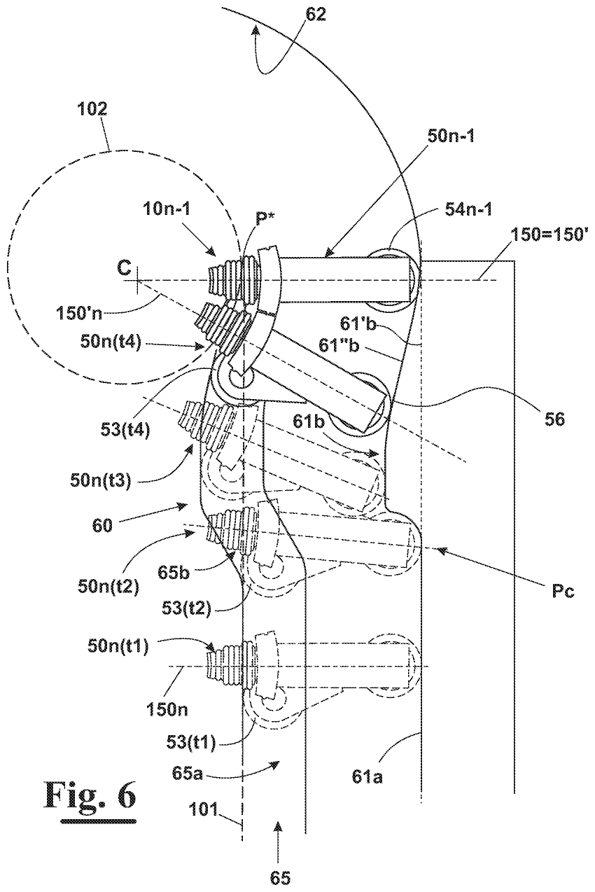

According to the invention, and diagrammatically illustrated in the sequence of FIG. 6, the apparatus 100 comprises an additional device 60 for changing the spatial orientation of the last pole member 10n at a point of change Pc of the rectilinear trajectory 101 positioned upstream of passage position P. In particular, in FIG. 6, for reasons of explanation, only the last pole member 10n, which is supported by the last support member 50n, is shown in different instants, in particular 4 different instants (t1,t2,t3,t4) until it is positioned adjacent to the previous pole member 10n-1 supported by support member 50n-1.

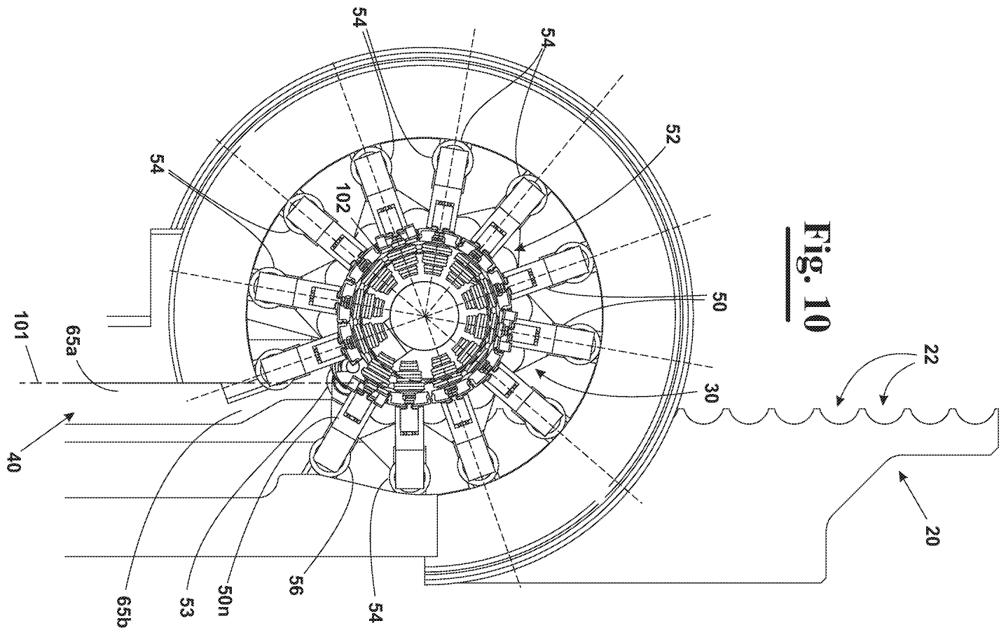

More precisely, with reference to FIG. 6, the last support member 50n is moved to change the predetermined starting spatial orientation of the last pole member 10n (instant t1) in which its winding axis is originally positioned in the first spatial orientation to a final spatial orientation (instant t4) in which the last pole member 10n is radially oriented with the respective winding axis 150n directed towards the centre (C) of the circular trajectory 102. In this way, it is possible to close the train of pole members 5, in particular by positioning all the pole members 10a, 10i and 10n supported by respective support members 50a, 50 and 50n on the circular trajectory 102 (see FIG. 11).

More in detail, from the predetermined starting spatial orientation of the last pole member 10n in which its winding axis 150n is directed along the first spatial orientation (instant t1), the device 60 for changing gradually causes the spatial orientation of the last pole member 10n to change when it reaches the change position Pc (see FIG. 6) moving along the rectilinear trajectory 101 (instants t2 and t3) up to be radially oriented with respect to centre (C) of the circular trajectory 102 (instant t4) and all the pole members 10a-10n are positioned along the circular trajectory 102.

In particular, as diagrammatically shown in FIG. 6, the last pole member 10n is caused to move forward from the rectilinear trajectory 101 and to rotate around an instantaneous axis of rotation orthogonal to the respective winding axis 150n.

In this way, the spatial orientation of the last pole member 10n undergoes a sequence of movements that is different from those of the first and the intermediate pole members 10a and 10i to be positioned on the circular trajectory 102. This is particularly necessary to cause the last pole member 10n to be positioned without unwanted interference amongst the first pole member 10a and the last intermediate pole member 10n-1, which precedes the last pole member 10n in the train of pole members 5, on the circular trajectory 102 around centre (C) that has been chosen.

In this way, the circular trajectory 102 for assembly all the pole members can be chosen in order to have a diameter that is large enough to allow all the pole members 10a, 10i and 10n of the train of pole members 5 to be positioned on it one adjacent to another, but to be, at the same time, as small as possible in order to avoid that the pole members 10a, 10i and 10n can move from the correct relative position from each other during assembly operations, in particular when the assembled pole members 10i and 10n are radially pressed in order to achieve the final shape of the annular stator to be obtained as anticipated above.

According to a possible embodiment of the invention, the first displacement device 20 (see for example FIGS. 2 and 5) comprises a first plurality of engagement seats 22 positioned side by side and according to a direction parallel to the rectilinear trajectory 101 along which the train of pole members 5 is moved by the first displacement device 20.

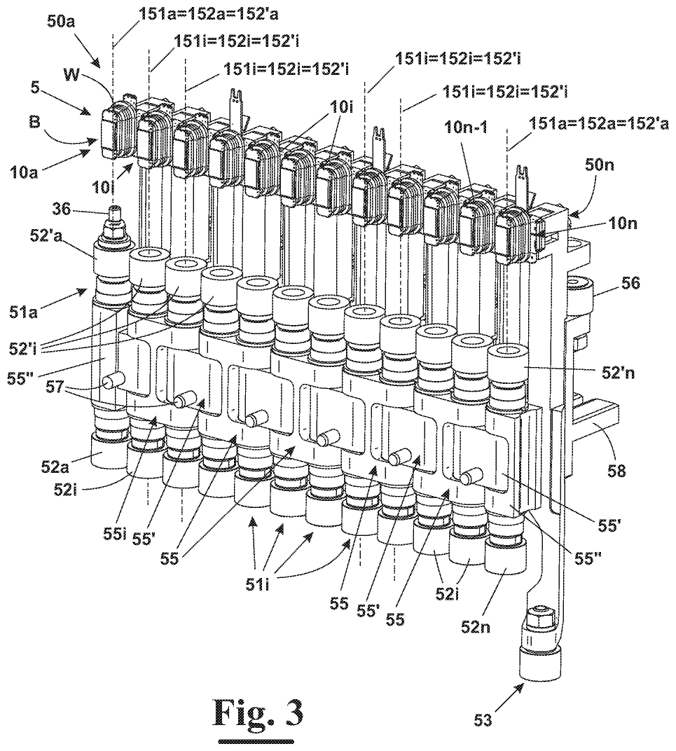

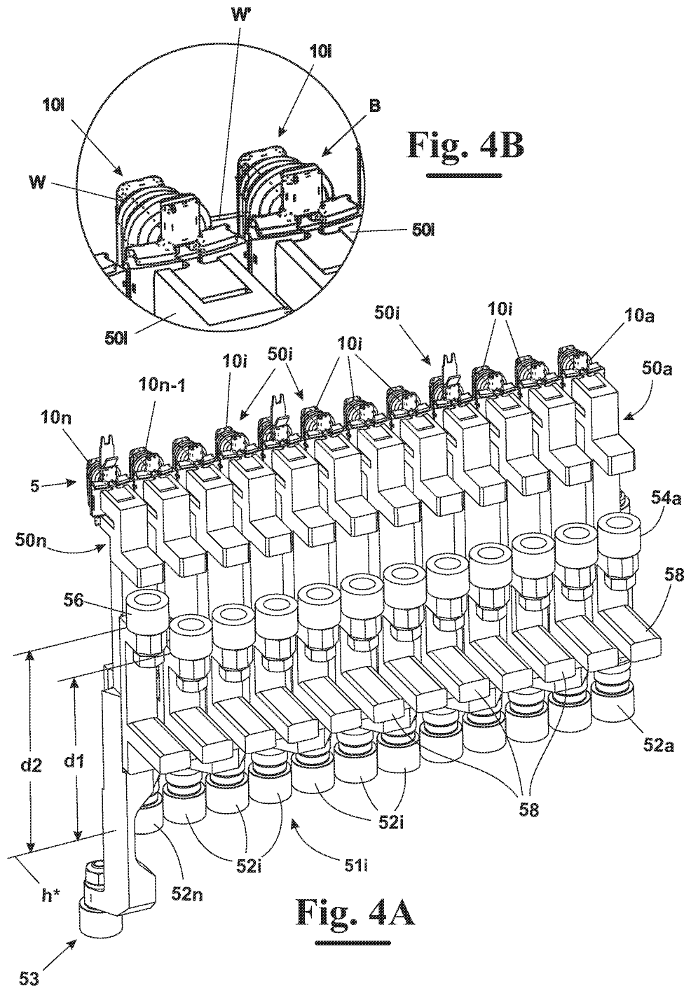

In particular, as shown in detail in FIGS. 3 and 4, according to a preferred embodiment of the invention, the first support member 50a, the intermediate support members and the last support member 50n are provided with respective engagement portions 55, 55′. These are arranged to engage with the engagement portion of the adjacent support member 50i-50n forming a chain of support members. More in particular, each support member 50 of the chain of support members is arranged to engage with the adjacent support member 50 free to rotate about a rotation axis 155a, 155i and 155n.

More precisely, a plurality of engagement members 51a, 51i, 51n, are provided for engaging an engagement portion of each support member 50a, 50i, and 50n with the engagement portion 55 of the adjacent support member 50a, 50n. More in detail, the engagement portions 55 and the engagement members 51a, 51i and 51n are configured in such a way that each support member 50a, 50i, and 50n is arranged to engage with the adjacent support member 50a, 50i, and 50n free to rotate around a respective rotation axis 151a, 151i and 151n (see FIG. 3).

In particular, as diagrammatically shown in FIG. 3, the intermediate support member 50i comprises intermediate support member 50i provided with an engagement portion 55 of a first type adjacent to an intermediate support member provided with an engagement portion 55′ of a second type. More in particular, the engagement portion 55 of the first type and the engagement portion 55′ of the second type are configured to be pivotally connected to each other by a respective engagement member 51i. Preferably, the engagement portion 55 of the first type and the engagement portion 55′ of the second type can have complementary shapes. For example, the engagement portion 55 of the first type can be substantially “I-shaped”. In this way the intermediate support member 50i are linked to each other at the respective engagement portions 55 and 55′ forming a chain of support members. Advantageously, the first support member 50a and the last support member 50n are provided with a respective engagement portion 55″ of a third type. In particular, the engagement portion 55″ of the third type are configured to be pivotally connected by a respective engagement member 51i to a respective engagement portion of the second type of the adjacent intermediate support member 50i.

According to an embodiment of the invention diagrammatically shown for example in FIG. 5, each engagement member 51a, 51i and 51n comprises a first engagement portion 52a, 52i and 52n arranged to engage with a respective engagement seat 22 of the first displacement device 20 (see for example FIG. 5). In this way, the chain of support members 50a-50n can be moved by the first displacement device 20 in order to move the train of pole members 5 along the rectilinear trajectory 101 in a very accurate way, in particular maintaining each pole member 10i and 10n at a predetermined distance from an adjacent pole member 10a, 10i and 10n and oriented according to the starting spatial orientation.

According to an advantageous embodiment of the invention, the first engagement portions 52a, 52i and 52n can comprise first rollers, arranged to be free to rotate about respective rotation axes 152a, 152i, 152n. In this case, each first engagement seat 22 of the first displacement device 20 can be circular-shaped and provided with a respective opening 23 (see for example FIG. 5) through which a respective first engagement portion 52a, 52n and 52i can enter/or exit the respective first engagement seat 22 to be engaged or disengaged.

Advantageously, in order to stabilize the movement of the support members 50a, 50n and 50i during their movement by the first displacement device 20, in particular avoiding unwanted tilting, at least a part of the support members 50i and 50n can be provided with first stabilization members 57 (see FIG. 3), for example stabilizing pins 57. In particular, the stabilizing pins 57 can be arranged to move into a rectilinear groove 27 that is foreseen parallel to the rectilinear trajectory 101 (see FIGS. 2 and 3). Advantageously, during their movement by the second displacement device 30 the stabilizing pins 57 can be arranged to move into a circular groove, not shown in the figures for clarity, that is foreseen coaxial to the circular trajectory 102.

For example, the first stabilizing pins 57 can protrude from the support members 50a, 50i and 50n at the opposite side of the first displacement device 20.

As diagrammatically shown for example in FIGS. 1 2 and 5, the second displacement device 30 can be provided with a second plurality of engagement seats 32. More in detail, the engagement members 51a, 51i and 51n can provide respective second engagement portions 52′a, 52′i and 52′n (see also FIG. 3) arranged to engage respective engagement seats 32 of the second plurality of engagement seats 32 of the displacement device 30 in order to move the respective pole members 10a, 10i and 10n along the circular trajectory 102. More in detail, the first engagement portions 52a, 52i and 52n, and the second engagement portions 52′a, 52′i and 52′n are arranged on respective planes parallel with each other. As shown in FIG. 3, the rotation axes 151a, 151i and 151i of the engagement members 51a, 51i and 51n preferably coincides with the rotation axes 152a, 152i and 152i of the first engagement portions and with the rotation axes 152′a, 152′i and 152′i of the second engagement portions, i.e. 151a=152a=152′a, 151i=152i=152′i and 151n=152n=152′n.

Therefore, the first and the second displacement devices 20 and 30 are configured to engage the support members 50a, and 50n at respective planes parallel with each other. In this way, it is possible to avoid any interference between the first and the second displacement devices 20 and 30, in particular at the passage position P.

In particular, the second displacement device 30 is provided with a hook-engagement member 35 (see for example FIG. 1) which engages a pin portion 36 (see FIGS. 1 and 3) of the first support member 50a starting from the predetermined passage position P* when the second engagement portion 52′a of the first support member 50a engages a respective second engagement seat 32 of the second displacement device 30.

According to an advantageous embodiment of the invention, the second engagement portions 52′a, 52′n and 52′i can comprise second engagement rollers configured to be free to rotate about respective rotation axes 152′a, 152′i and 152′n as shown in FIG. 3. In this case, each second engagement seat 32 of the second displacement device can be circular-shaped and provided with a respective opening 33 through which a respective second engagement portion 52′a, 52′i and 52′n can enter/or exit the respective second engagement seat 32 (see for example FIG. 5).

According to an embodiment of the invention diagrammatically shown in FIGS. 3 and 4, the first engagement portion 52a, 52i and 52n and the second engagement portion 52′a, 52′i and 52′n of the same engagement member 51a, 51i and 51n can be coaxial one another and positioned at the same side of the support member 50a, 50i and 50n, but at different heights. More in detail, the first and second displacement devices 20 and 30 are synchronized one another in such a way that at the passage position P* the openings 23 and 33 respectively of a first and a second engagement seats 22 and 32 face each other even though at different heights (see FIG. 5). In this way, when a support member 50a, 50i, and 50n moved by the first displacement device 20 reaches the passage position P*, the second engagement portion 52′a, 52′i and 52′n of the respective support member 50a, 50i and 50n moves into a respective engagement seat 32 of the second displacement device 30 in order to move the respective pole member 10a, 10i and 10n along the circular trajectory 102, and the first engagement portion 52a, 52i and 52n leaves the first engagement seat 22 to be disengaged from the first displacement device 20.

In particular, the second displacement device 30 can be a rotating crown, or carousel, peripherally provided with the second plurality of engagement seats 32. More in particular, the second displacement device 30 can be caused to rotate about a rotation axis 130 passing through the centre (C) by a driving group 80 (shown in FIG. 2), in particular comprising an electric motor, in order to cause the first support member 50a and the intermediate support members 50i engaged at respective engagement seats 32 to be moved along a circular direction coaxial to the circular trajectory 102 along which the respective pole members 10a, and 10n are moved.

As diagrammatically shown in FIG. 4, at least a part of the support members 50 can be provided with respective second stabilization members 58 (shown in FIGS. 3 and 4), in particular arranged at the opposite side of the first stabilization members 57 with respect to the support members 50. In particular, during the movement of the train of pole members 5 along the rectilinear trajectory 101 the second stabilization members 58 can be arranged to move into a rectilinear groove, not shown in the figures for clarity, in particular provided with a rectilinear abutment surface. Advantageously, during the movement of the train of pole members 5 along the circular trajectory 102 the second stabilization members 58 can be arranged to move into a circular groove 39, in particular against a rectilinear abutment surface, in order to stabilize the movement of the support members 50, in particular to avoid tilting (see FIG. 2).

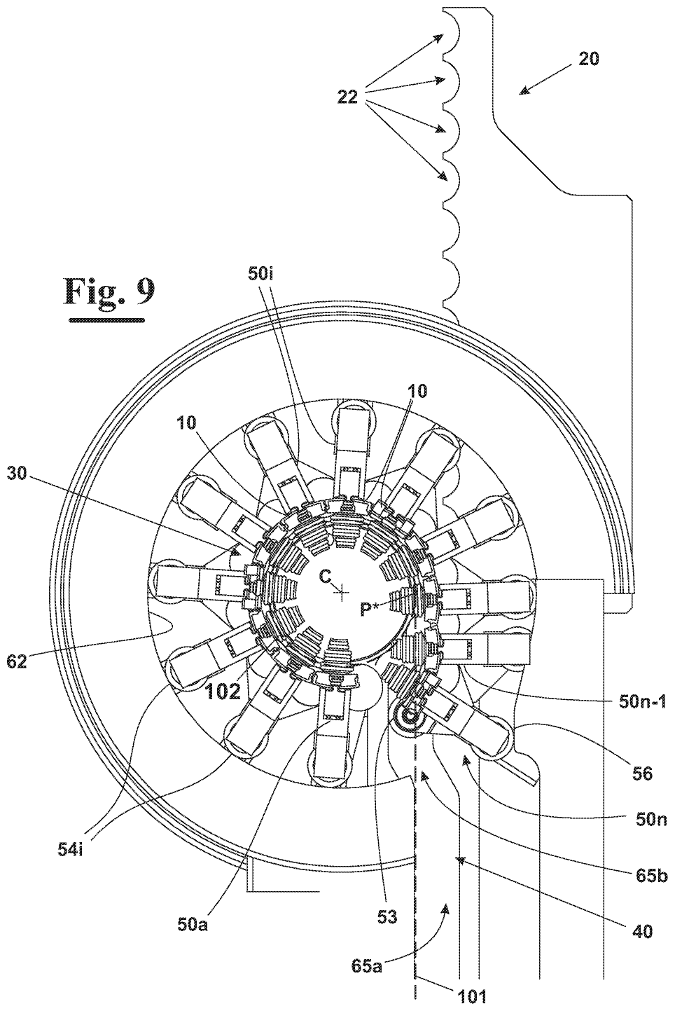

According to a preferred embodiment of the invention, the device 60 (see for example FIGS. 2, 6 and 9) for changing the spatial orientation of the last support member can provide a guide member 65, in particular a guide groove 65, and the last support member 50n can be provided with a third engagement portion 53 (see for example FIGS. 2, 3 and 4) arranged to engage with the guide member 65. Advantageously, the third engagement portion 53 is positioned at a different height, in particular at a lower height, with respect to the first engagement portions 52a, 52i and 52n of the engagement members 51a, 51i and 51n.

In particular, the guide member 65 (see for example FIG. 1) comprises a first guide portion 65a parallel to the rectilinear trajectory 101, and a second guide portion which is shaped, in particular cam-shaped, in such a way that the movement of the first displacement device 20 along the moving direction 120 carried out by the second displacement device 20 causes, when the third engagement portion 53 moves along the second guide portion 65b, the last support member 50n to rotate around the rotation axis 151n of the respective first engagement portion 51n changing the spatial orientation of the winding axis 150n of the last pole member 10n from the predetermined starting spatial orientation to a final spatial orientation in which it is radially oriented with respect to the circular trajectory 102.

In particular (with reference to FIGS. 3 and 4), the support members 50a, 50i and 50n can be provided with respective contact portions 54. More in particular, the contact portions 54 of the first and intermediate support members 50a and 50i are positioned at a first distance d1 from a reference height h*, whilst the contact portion 56 of the last support member 50n is positioned at a second distance d2 from the reference height h* different from the first distance d1, for example the second distance d2 can be greater than the first distance d1.

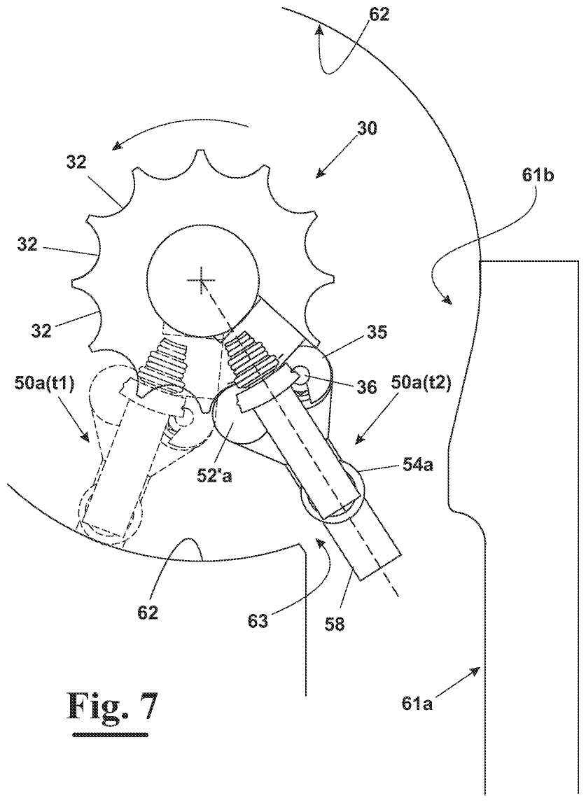

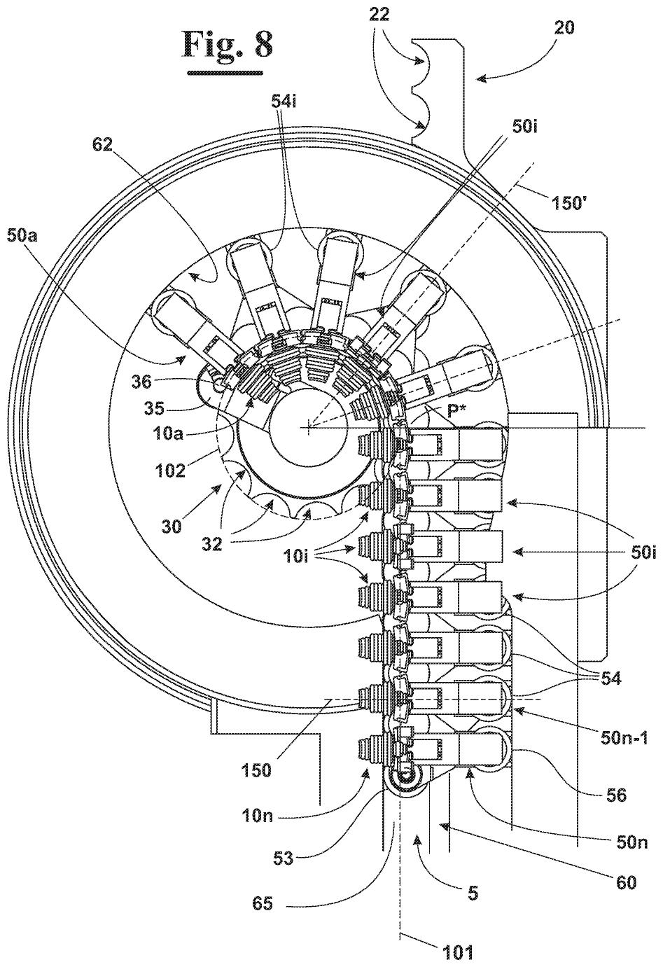

More in particular, a first stabilization wall 61 (see FIGS. 1, 5, 6 and 8) can be provided comprising a first portion 61a parallel to the rectilinear trajectory 101 along which the contact portions 54a, 54i, and 56, respectively of the first, the intermediate, and the last support members 50i, and 50n are arranged to move during a first portion of the movement of the first displacement device 20 along the moving direction 120. Furthermore, the first stabilization wall 61 (see FIG. 6) comprises a second portion 61b comprising a first part 61′b arranged at the first distance d1 from the reference height h* and parallel to the rectilinear trajectory 101 along which the contact portions 54a, and 54i of the first and intermediate last support members 50a, and 50i are arranged to move during a second portion of the movement of the first displacement device 20 along the moving direction 120 up to reaching the passage position P. In addition, the second portion 61b of the first stabilization wall 61 comprises a second part 61″b arranged at the second distance d2 from the reference height h*. In particular, the second part 61″b is shaped substantially as the second portion 65b of the guide member 65. In this way, during the second portion of the movement of the first displacement device 20 along the moving direction 120, the contact portion 56 of the last support member 50n moves along the second part 61″b of the second portion 61b, and the third engagement portion 53 of the last support member 50n moves along the second guide portion 65b of the guide member 65. In particular, when the second engagement portions 52′a, 52′i and 52′n engage with the second engagement seats 32 of the second displacement device 30 at passage position P*, the contact portions 54a, 54i and 56 moves along a second stabilization wall 62, which has a circular shape concentric to the circular trajectory 102. In particular, the second stabilization wall 62 is positioned at the opposite side of the second displacement device 30 with respect to the support members 50 (as shown in FIG. 2). As diagrammatically shown for example in FIGS. 5 and 7, the second stabilization wall 62 interrupts at a predetermined position of the circular trajectory 102 forming an aperture 63. In particular, the aperture 63 allows to the support members 50a and 50i moved along the rectilinear trajectory 101 to be positioned at the passage position P*. In fact, the first and the second displacement devices 20 and 30 are configured to move the support members on the same plane, respectively along the rectilinear and circular trajectories 101 and 102. Furthermore, the aperture 63 allows also to change the spatial orientation of the last support member 50n.

When the first pole member 10a supported by the first support member 50a, during its movement along the circular trajectory 102, arrives at the aperture 63, in order to be able to continue to be moved on the circular trajectory 102, it is guided by the hook-engagement member 35, even though the contact member 54a of the first support member no longer moves along the second stabilization wall 62, and the second stabilization member 58 is no longer arranged in the circular groove 39. This is diagrammatically illustrated in FIG. 7 where only the first support member in two different instants (t1 and t2) is shown for reasons of explanation.

In particular, according to an aspect of the invention diagrammatically shown in FIGS. 4B and 11B, each pole 10i and 10n of the train of pole members 5 can be constrained to the adjacent pole member 10a, 10i and 10n by at least a connection lead W′ of the wire W having a predetermined length. Therefore, it is fundamental, in this case, to accurately position each pole member 10a, 10i and with respect to the adjacent pole member 10a, 10i and during their movements both along the rectilinear trajectory 101 and the circular trajectory 102, in order to avoid breaking, or other damage to the wire W and or to the connection leads W′ connecting the poles. In this case the circular trajectory 102 for assembly of the poles 10a, 10i and 10n around centre (C) can be selected to suit the placement of the connection leads without causing the latter to be over-length or too short and become stretched during assembly. More in detail, circular trajectory 102 can be selected where pole members are assembled like has been described in the foregoing with reference to the positioning of the pole members of the train of pole members 5 and, in particular, the last pole member 10n, on the circular trajectory 102.

In the figures from 12 to 14 an exemplary embodiment of an intermediate support member 50i provided with an engagement portion 55 of the first type is diagrammatically shown in a perspective, cross-sectional, and plan view, respectively.

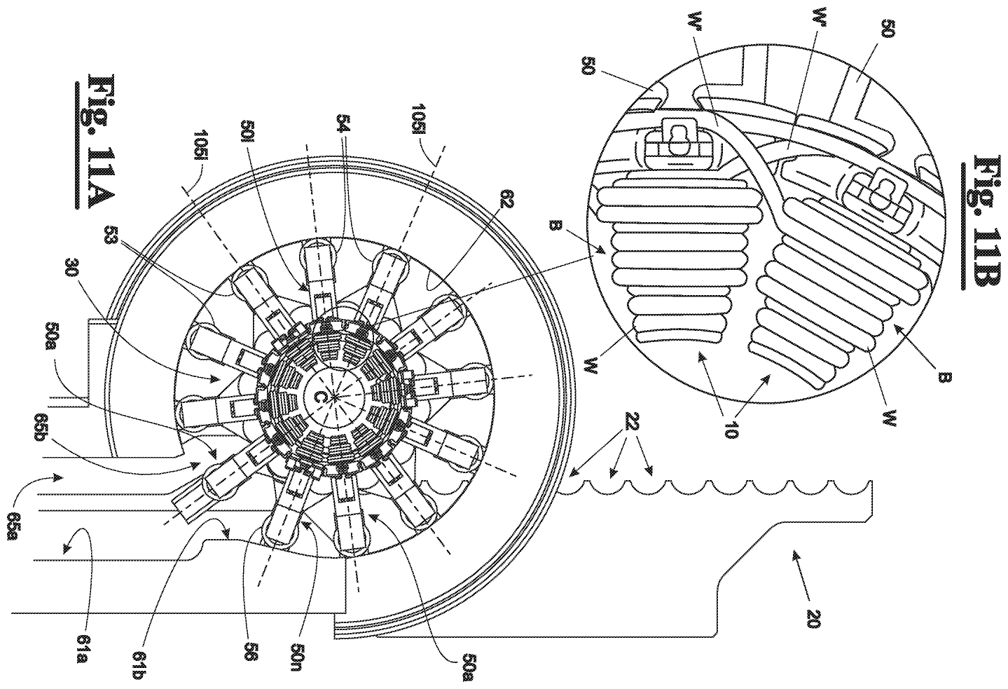

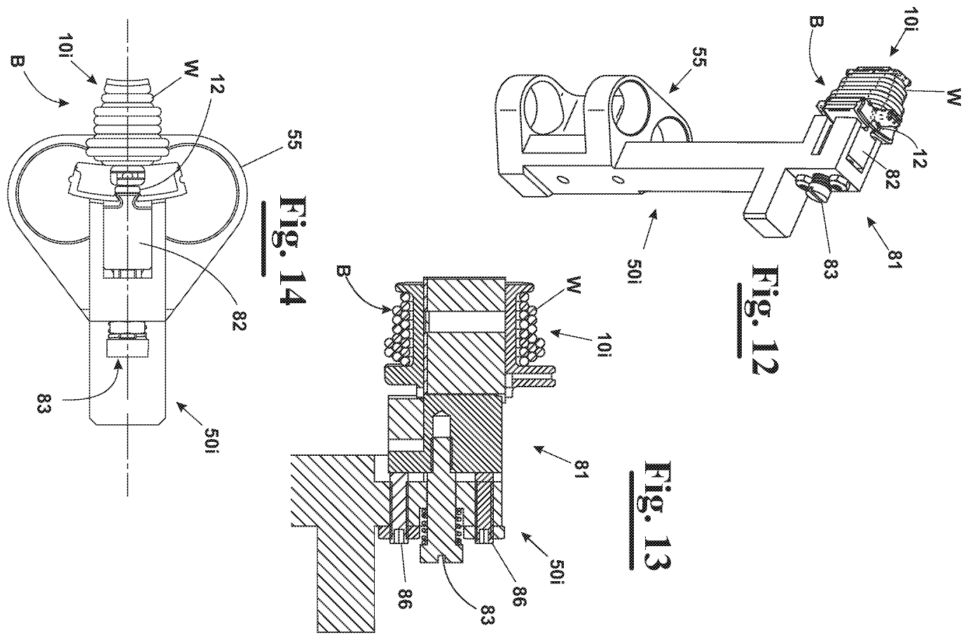

As diagrammatically shown, in particular, in FIGS. 12, 13 and 14, the support member 50i provided with an engagement portion 55 of the first type can comprise a holding device 81. More in particular, the holding device 81 can be provided with a holding member 82 removably engaged in a slot 12 of the pole 10 (see FIG. 14). The holding member 82 is fixed to spring loaded screw 83, which draws holding member 82 against pins 86 (as shown in FIGS. 13 and 14) for fixing the pole 10 to the support member 50i thus assuring a correct positioning of the pole members 10i along the rectilinear and circular trajectories 101 and 102, when the support member 50i is moved by the first and second displacement devices 20 and 30, respectively.

The foregoing description exemplary embodiments of the invention will so fully reveal the invention according to the conceptual point of view, so that others, by applying current knowledge, will be able to modify and/or adapt for various applications such embodiment without further research and without parting from the invention, and, accordingly, it is therefore to be understood that such adaptations and modifications will have to be considered as equivalent to the specific embodiments. The means and the materials to realize the different functions described herein could have a different nature without, for this reason, departing from the field of the invention. It is to be understood that the phraseology or terminology that is employed herein is for the purpose of description and not of limitation.

1. A method for producing a stator of a dynamo-electric machine by assembling together a plurality of pole members wound with wire around respective winding axis forming respective coils, said method comprising the steps of:
moving along a predetermined rectilinear trajectory a train of pole members comprising said plurality of pole members positioned side by side, said train of pole members comprising a first pole member, a last pole member, and a predetermined number of intermediate pole members positioned between said first and said last pole members during said step of moving along the predetermined rectilinear trajectory each pole member being arranged with the respective winding axis positioned according to a predetermined starting spatial orientation;
moving at a predetermined passage position of the rectilinear trajectory the first pole member and the intermediate pole members from the rectilinear trajectory to a circular trajectory having a centre;
moving the first pole member and the intermediate pole members, during said step of moving along the circular trajectory), said first pole member and said intermediate pole members being caused to rotate around a rotation axis passing through said centre in such a way that the winding axes of the first pole member and the intermediate pole members is directed towards the centre of said circular trajectory;
causing at a change point of said rectilinear trajectory positioned upstream of said passage position, the last pole of said train of pole members to move forward from said rectilinear trajectory and to rotate around an instantaneous axis of rotation orthogonal to said respective winding axis to position said last pole member with the respective winding axis radially oriented with respect to said circular trajectory upstream of said passage position in such a way to close the train of pole members by positioning the last pole member adjacent to the first pole member and to the intermediate pole member of the train of pole members which precedes the last pole member.

2. The method according to claim 1 wherein the adjacent pole members of the train of pole members are connected by connection leads.

3. The method according to claim 1, wherein a plurality of support members is, furthermore, provided arranged to support respective pole members of said plurality of pole members, said plurality of support members comprising,
a first support member;
a last support member; and
a predetermined number of intermediate support members positioned between the first and the last support members, wherein each support member comprises a respective engagement portion at which each support member is arranged to engage by a respective engagement member with the adjacent support member in order to be free to rotate about a rotation axis in such a way to form a chain of support members.

4. The method according to claim 3, wherein during said step of moving along said rectilinear trajectory the first, the intermediate, and the last support members are engaged at first engagement portions of said respective engagement members to a first displacement device arranged to move along a moving direction parallel to said rectilinear trajectory.

5. The method according to claim 3, wherein at the predetermined passage position and during the step of moving along said circular trajectory said first, said intermediate, and said last support members are engaged at second engagement portions of respective engagement members to a second displacement device arranged to cause said train of pole members to move along said predetermined circular trajectory.

6. The method according to claim 5, wherein during the step of moving along the circular trajectory each support member is rotated by the second displacement device around a rotation axis passing through the centre of said circular trajectory maintaining the winding axes of the pole members radially oriented with respect to the centre of the circular trajectory.

7. The method according to claim 3, wherein said step of changing the spatial orientation of the last pole member is carried out by a device for changing the spatial orientation arranged to engage the last support member at a third engagement portion with a guide member comprising a first guide portion parallel to said rectilinear trajectory, and a second guide portion shaped in such a way to cause the last support member to rotate around the rotation axis of the respective first engagement portion changing the spatial orientation of the winding axis of the last pole member from the predetermined starting spatial orientation to a final spatial orientation in which it is radially oriented with respect to the circular trajectory.

8. The method according to claim 3, wherein during the moving step of the pole members along the circular trajectory a contact portion of each support member is arranged to move along a second stabilization wall having a curvilinear shape and positioned at the opposite side of said second displacement device, said second stabilization wall interrupting at a predetermined angular position of said circular trajectory in order not to obstruct said the step of changing the spatial orientation of the winding axis of the last pole member.

9. An apparatus for producing a stator of a dynamo-electric machine by assembling together a plurality of pole members wound by a wire around respective winding axis forming respective coils, said apparatus comprising:
a first displacement device configured to move along a predetermined rectilinear trajectory a train of pole members comprising said plurality of pole members positioned side by side, said train of pole members comprising a first pole member, a last pole member, and a predetermined number of intermediate pole members positioned between said first and said last pole members, said first displacement device configured to move said plurality of pole members maintaining the respective winding axes positioned according to a predetermined starting spatial orientation;
a second displacement device configured to cause, at a predetermined passage position of the rectilinear trajectory, the first pole member and the plurality of intermediate pole members at a time to move from said predetermined rectilinear trajectory a predetermined circular trajectory having a centre, and wherein said second displacement device is configured to move said plurality of pole members along the circular trajectory causing said plurality of pole members to rotate around a rotation axis passing through said centre in such a way to maintain the winding axes of said pole members radially oriented with respect to the centre;
a device for changing at a change point of said rectilinear trajectory positioned upstream of said passage position, the spatial orientation of the last pole member causing the last pole member to move forward from said rectilinear trajectory and to rotate around an instantaneous axis of rotation orthogonal to said respective winding axis to position the winding axis of the last pole member radially oriented with respect to the centre of the circular trajectory in such a way to close the train of pole members by positioning the last pole member adjacent to the first pole member and to the intermediate pole member of the train of pole members which precedes the last pole member.

10. The apparatus according to claim 9 wherein a plurality of support members is, furthermore, provided arranged to support respective pole members of said plurality of pole members, said plurality of support members comprising a first support member a last support member and a predetermined number of intermediate support members positioned between the first and the last support members, and wherein each support member comprises a respective engagement portion at which each support member is arranged to engage by a respective engagement member with the adjacent support member in order to be free to rotate about a rotation axis in such a way to form a chain of support members.

11. The apparatus according to claim 10, wherein the first displacement device is provided with a first plurality of engagement seats, and wherein said engagement members of said first, intermediate and last support members are provided with respective first engagement portions arranged to engage with respective engagement seats of said first plurality of engagement seats to move said respective pole members along said rectilinear trajectory.

12. The apparatus according to claim 11, wherein said second displacement device is provided with a second plurality of engagement seats and wherein said engagement members of said first, intermediate and last support members are provided with respective second engagement portions arranged to engage with respective engagement seats of said second plurality of engagement seats to move said respective pole members along said circular trajectory.

13. The apparatus according to claim 10, wherein said second displacement device is provided with a hook-engagement member configured to engage a pin portion of the first support member starting from the predetermined passage position when the second engagement portion of the first support member is engaged with a respective second engagement seat of the second displacement device.

14. The apparatus according to claim 12, wherein said second displacement device is a rotating crown peripherally provided with the second plurality of engagement seats, said second displacement device being configured to cause said plurality of support members to rotate around a rotation axis passing through said centre of said circular trajectory.

15. The apparatus according to claim 11, wherein said first portions and said second portions of said engagement members are arranged on respective planes parallel with each other.

16. The apparatus according to claim 11, wherein said device for changing the spatial orientation of the last pole member provides a guide member and wherein said last support member is provided with a third engagement portion arranged to engage with said guide member, said guide member comprising a first guide portion parallel to said rectilinear trajectory and a second guide portion shaped in such a way to cause the last support member rotate around the rotation axis of the respective first engagement portion changing the spatial orientation of the winding axis of the last pole member from the predetermined starting spatial orientation to a final spatial orientation in which it is radially oriented with respect to the circular trajectory.

17. The apparatus according to claim 11, wherein said support members are provided with respective contact portions arranged to move along a second stabilization wall having a circular shape concentric to said circular trajectory during said movement by said second displacement device, said second stabilization wall interrupting at a predetermined angular position of said circular trajectory in order not to obstruct said the step of changing the spatial orientation of the winding axis of the last pole member.

18. The apparatus according to claim 17, wherein the contact portions of said first and intermediate support members are positioned at a first distance from a reference height, and wherein the contact portion of said last support member of said last pole is positioned at a second distance from said reference height different from said first distance and wherein a first stabilization wall is, furthermore, provided comprising:
a first portion parallel to the rectilinear trajectory along which said contact portions of said first, intermediate, and last support members are arranged to move during a first portion of the movement of said first displacement device along said moving direction;
a second portion comprising:
a first part arranged at the first distance from said reference height and parallel to said rectilinear trajectory along which said contact portions of the first and intermediate last support members are arranged to move during a second portion of the movement of said first displacement device along said moving direction up to reach the passage position;
a second part arranged at the second distance from the reference height and shaped substantially as said second portion of the guide member, in such a way that that during the second portion of the movement of said first displacement device along said moving direction, the contact portion of said last support member is arranged to move along the second part of said second portion, and the third engagement portion of said last support member is arranged to move along said second guide portion of said guide member.
